(19) United States
(12) Patent Application Publication
(10) Pub. No.: US 2016/0075298 A1
(43) Pub. Date: Mar. 17, 2016

(54) OCCUPANT PROTECTOR

(71) Applicants: Nissan Motor Co., Ltd., Kanagawa (JP); Calsonic Kansei Corporation, Saitama (JP)

(72) Inventors: Shiro Ozawa, Kanagawa (JP); Satoshi Furusawa, Kanagawa (JP); Satoshi Takeda, Kanagawa (JP); Masato Abe, Saitama (JP)

(73) Assignees: Nissan Motor Co., Ltd., Kanagawa (JP); Calsonic Kansei Corporation, Saitama (JP)

(21) Appl. No.: 14/857,444

(22) Filed: Sep. 17, 2015

(30) Foreign Application Priority Data
Sep. 17, 2014 (JP) 2014-188684

(51) Int. Cl. B60R 21/045; B60R 7/06

(52) U.S. Cl. CPC B60R 21/045; B60R 7/06; B60R 2021/0002

(57) ABSTRACT

An occupant protector has a steering member elongated in a lateral direction of a vehicle, a glove box disposed rearward relative to the steering member, and having a lid openable to a compartment of the vehicle, and an impact absorber interposed between the steering member and the lid that is operable to be deformed by and to absorb an impact on the lid.

### CROSS-REFERENCE TO RELATED APPLICATIONS

This application is based upon and claims the benefit of priority to the Japanese Patent Application No. 2014-188684 (filed Sep. 17, 2014), the entire contents of which are incorporated herein by reference.

### BACKGROUND OF THE INVENTION

1. Field of the Invention

The present disclosure relates to an occupant protector that protects an occupant at a time of having his/her legs jammed against a glove box.

2. Description of the Related Art

There has been a proposed occupant protector applied to a glove box, which is crushable by impact of occupant's legs on the glove box to protect the legs from being broken. Japanese Patent Application Laid-open No. H08-318788 discloses a related art.

### SUMMARY OF THE INVENTION

While an air conditioner usually stands in front of a glove box, the air conditioner is not sufficiently rigid or structurally strong to receive the impact of the legs after crushing the glove box. Addition of reinforcement members is required but this of course causes issue of cost and weight increase.

An occupant protector according to one or more embodiments of the present invention comprises a steering member elongated in a lateral direction of a vehicle, a glove box disposed rearward relative to the steering member, the glove box including a lid openable to a compartment of the vehicle, and an impact absorber interposed between the steering member and the lid and operable to be deformed by and to absorb impact on the lid.

### BRIEF DESCRIPTION OF THE DRAWINGS

FIG. 1 is a perspective view of a glove box, an occupant protector and other member related thereto according to a first embodiment.

FIG. 2 is a perspective view of the glove box, the occupant protector, which shows back sides thereof.

FIG. 3 is a perspective view of a steering member.

FIGS. 4A and 4B are sectional views of the glove box shown in FIG. 1, in which FIG. 4A shows a closed state and FIG. 4B shows an opened state.

FIGS. 5A and 5B are sectional views of the glove box shown in FIG. 1, in which FIG. 5A shows a state where an absorber is of an initial shape and FIG. 5B shows a state where the absorber is deformed.

FIGS. 6A and 6B are elevational views of the steering member, in which FIG. 6A shows a state where a load is imposed on a laterally inner part and FIG. 6B shows a state where a load is imposed on a laterally outer part.

FIG. 7 is a plan view of the glove box and the steering member, which is corresponding to FIG. 5A.

FIGS. 8A and 8B are sectional views of the glove box and the steering member, where FIG. 8A is taken from the line VIIIA-VIIIA in FIG. 7 and FIG. 8B is taken from the line VIIIB-VIIIB.

FIGS. 9A and 9B are sectional views of the glove box and the steering member according to a second embodiment, which are respectively corresponding to FIGS. 5A and 5B.

### DETAILED DESCRIPTION

Exemplary embodiments will be described hereinafter with reference to the appended drawings. In embodiments of the invention, numerous specific details are set forth in order to provide a more thorough understanding of the invention. However, it will be apparent to one of ordinary skill in the art that the invention may be practiced without these specific details. In other instances, well-known features have not been described in detail to avoid obscuring the invention.

It is particularly noted that these drawings are not always drawn to scale exactly and therefore dimensional relations among elements are not limited to those shown therein. Arrows FR, UP and RH in the drawings depict forward, upward and right directions relative to a vehicle, respectively. Throughout the following description and the appended claims, directions are defined as those relative to the vehicle body unless otherwise described. In the exemplary vehicle, a driver sits at the right and a passenger sits at the left but of course an inverse embodiment is possible.

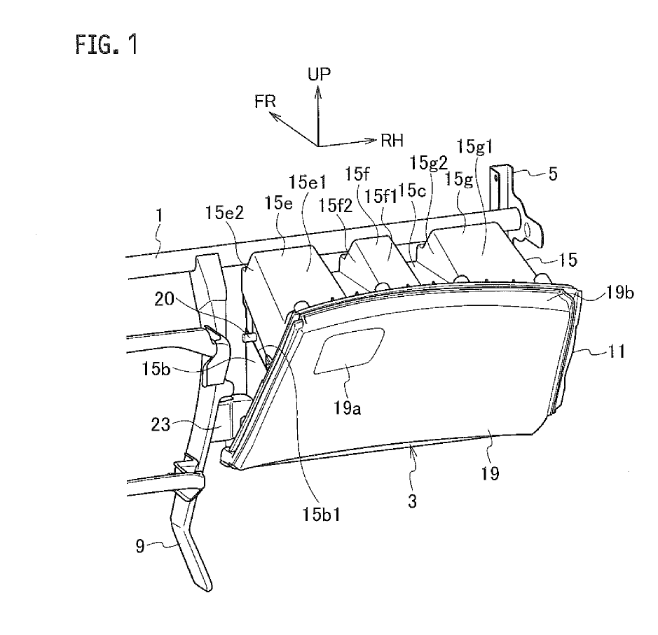

Referring mainly to FIG. 1, a steering member 1 runs in a lateral direction of the vehicle and is disposed in front of a glove box 3. The passenger seat is installed at the rear of the glove box 3 but is not shown in the drawings. More specifically, the glove box 3 stands in front of the passenger seat.

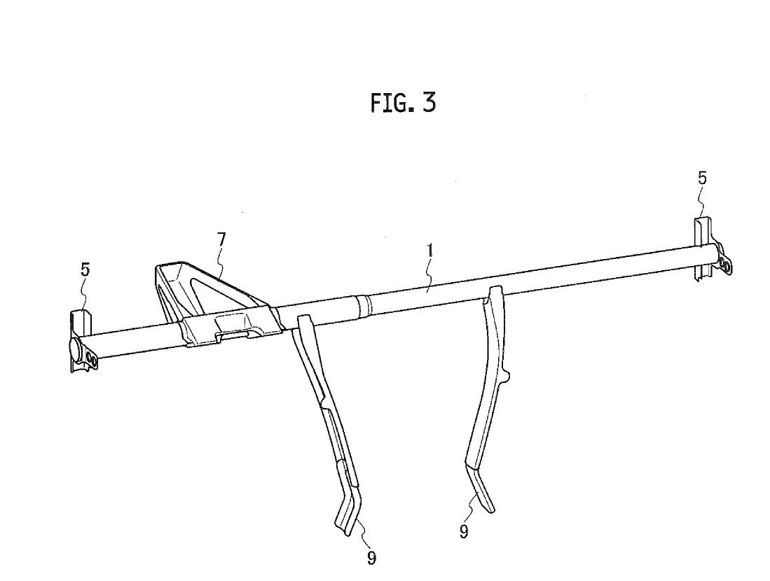

Referring to FIG. 3 in combination with FIG. 1, the steering member 1 is elongated in the lateral direction of the vehicle. The steering member 1 is comprised of sub-brackets 5 at both ends thereof, a post-bracket 7 elongated forward from a part thereof relatively closer to the driver side, and a pair of installer stays 9 elongated downward therefrom, thereby being installed in the vehicle body.

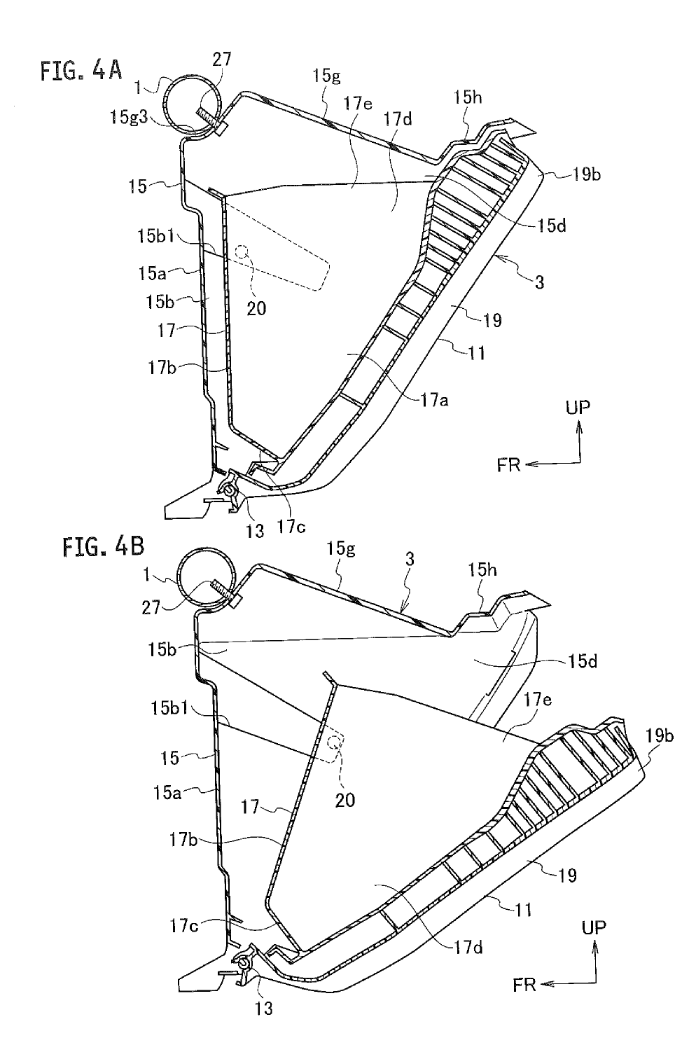

Referring to FIGS. 4A and 4B, the glove box 3 is comprised of a box body 11 and a box cover 15 for swingably supporting the box body 11. Lowermost ends of the box body 11 and the box cover 15 form a hinge portion 13 to allow the box body 11 to pivot and swing thereon, in which recesses of the box body 11 catch pins of the box cover 15 for example. Further the box body 11 is comprised of a housing portion 17 defining a cavity 17a and a lid 19 for sealing the cavity 17a. The lid 19 faces the compartment and is openable thereto. In addition, the lid 19 is, as shown in FIG. 1, comprised of a handle portion 19a to offer a handhold to an occupant.

Referring again to FIGS. 4A and 4B, the housing portion 17 is comprised of a front wall 17b at its front, a bottom wall 17c elongated obliquely downward from the front wall 17b, and side walls 17d at both sides thereof. The walls 17b,17c,17d in combination with the lid 19 define the cavity 17a but leave an opening 17e opened upward, through which articles can be dropped in the cavity 17a.

An occupant can grasp the handle portion 19a to move the box body 11 from the closed state shown in FIG. 4A to the opened state shown in FIG. 4B so as to have the opening 17e exposed. Then he or she can let articles in or out of the cavity 17a through the opening 17e. To retain the box body 11 in the opened state, the box body may have stopper pins 20 latching on ends of guiding slots 15b1 formed on side walls 15b described later.

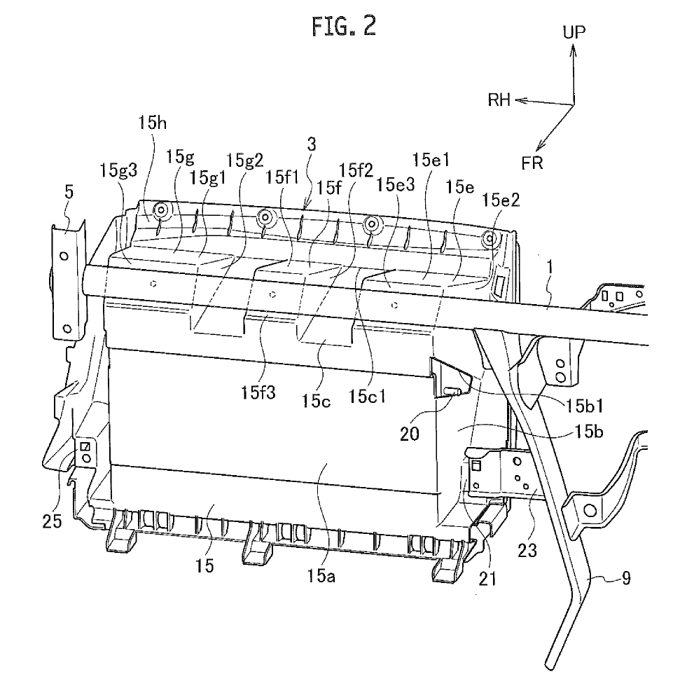

The box cover 15 is comprised of a front wall 15a, to which the front wall 17b of the housing portion 17 comes close when the box body 11 is in the closed state shown in FIG. 4A, and side walls 15b close to the side walls 17d of the housing portion 17. The box cover 15 is further, as best shown in FIGS. 1 and 2, comprised of an upper wall 15c, which hangs over the opening 17e of the box body 11 in the closed state. The walls 15a,15b,15c define a hollow 15d opened to the compartment, which receives the housing portion 17.

The hollow 15d is so dimensioned as to surround the cavity 17a of the housing portion 17 but brims of the lid 19 slightly spreads out of the opening of the hollow 15d so that the lid 19 covers this opening when the box body 11 gets in the closed state as shown in FIG. 4A.

Referring mainly to FIG. 2, one of the side walls 15b, at the side toward the driver, is comprised of an attachment 21 and the corresponding installer stay 9 is comprised of a bracket 23. As the attachment 21 is secure to the bracket 23 by means of bolts or such, the box cover 15 is secured to the installer stay 9. Another of the side walls 15b is comprised of another attachment 25, by which the box cover 15 is secured to an inner side wall of the dashboard (not shown).

The upper wall 15c of the box cover 15 is comprised of plural, three for example as shown in the drawings, corrugations 15e,15f,15g projecting upward therefrom. Each corrugation 15e,15f,15g is comprised of paired side walls 15e2,15f2,15g2 standing substantially upright, an upper wall 15e1,15f1,15g1 bridging top ends of the side walls 15e2,15f2,15g2, and a front wall 15e3,15f3,15g3 opposed to the steering member 1. While each corrugation 15e,15f,15g is similar to a triangular prism, the side walls 15e2,15f2,15g2 are similar to top and bottom faces thereof and the walls 15e1,15f1,15g1 and 15e3,15f3,15g3 are similar to side faces.

The side wall 15e2 of the corrugation 15e, which is closest to the driver seat among the side walls, may be formed as an extension of the side wall 15b of the box cover 15 so as to form a single face therewith. The side wall 15g2 may be similarly formed as an extension of the side wall 15g so as to form a single face therewith.

Each front face 15e3,15f3,15g3 is fastened with the steering member 1 by means of a bolt 27, thereby adjusting the corrugations 15e,15f,15g in place on the steering member 1. More specifically, the front faces 15e3,15f3,15g3 in combination with the bolts 27 constitute an adjuster structure as described later.

The corrugations 15e,15f,15g are thus interposed between the steering member 1 and the lid 19 and also constitute an impact absorber as described later.

Referring again FIGS. 4a and 4B, and further to FIG. 2, the upper wall 15c of the box cover 15 is, at an end 15c1 toward the compartment, elongated and bent upward to form a bent portion 15h. A top end portion 19b of the lid 19 is accordingly elongated upward, thereby covering the end 15c1 of the upper wall 15c.

The aforementioned structure acts in the following way.

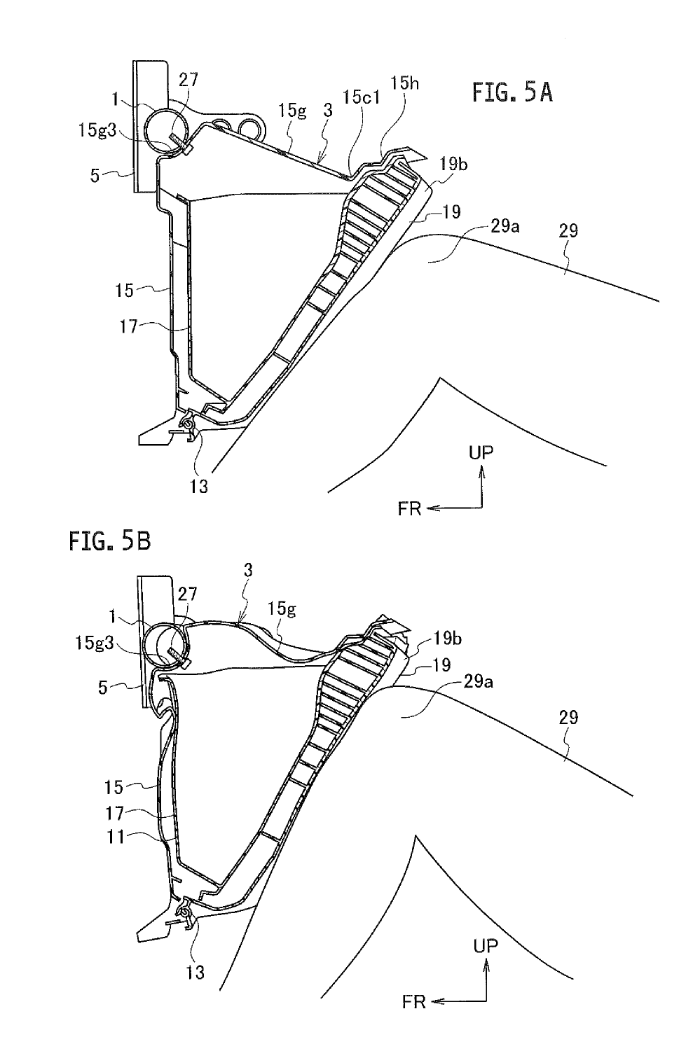

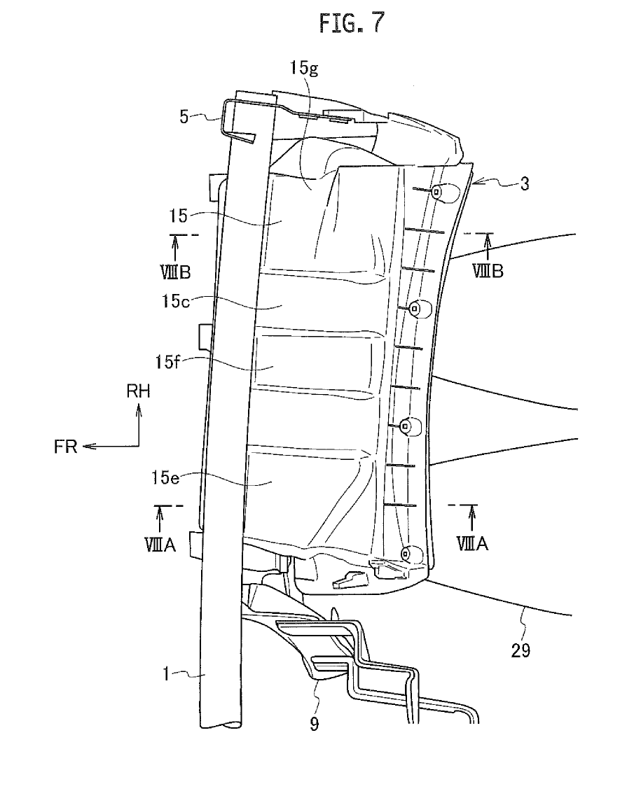

Referring to FIG. 5A, typically when the vehicle decelerates abruptly, an occupant 29 sitting on the passenger seat is occasionally plunged forward and his/her legs 29a may be then jammed against the lid 19. An impact load thus imposed on the lid 19 is transmitted through the top end portion 19b and the upper wall 15c to the corrugations 15e,15f,15g. As the right and left legs 29a are, usually, respectively aligned with the right and left corrugations 15g,15e as shown in FIG. 7, these corrugations 15g,15e mainly bear the load.

The corrugations 15e,15f,15g receiving the load press these front walls 15e3,15f3,15g3 onto the steering member 1. As being pinched between the steering member 1 and the lid 19, the corrugations 15e,15f,15g are deformed or broken to absorb the impact as shown in FIG. 5B.

As the right and left corrugations 15g,15e are aligned with the right and left legs 29a respectively, these corrugations 15g,15e effectively absorb the impact imposed by these legs 29a with small loss.

As the steering member 1 supports the corrugations 15e,15f,15g and is sufficiently rigid and structurally strong, it is needless to additionally provide the vehicle with any reinforcement members for receiving the impact. This is advantageous in reducing cost and weight.

Further, the imposed impact is absorbed mainly by deformation of the corrugations 15e,15f,15g and auxiliarily by deformation of the remainder of the box cover 15 as shown in FIG. 5B. The box body 11 and the lid 19 are therefore prevented from being deformed excessively. Thus it is needless to provide the glove box 3 with any reinforcement members. This enables a simplified structure for the glove box 3.

The corrugations 15e,15f,15g stand upward from the upper wall 15c and respectively have front faces 15e3,15f3,15g3. This structure enables the impact absorber to face and get in contact with the steering member 1.

The adjuster structure comprised of the front faces 15e3,15f3,15g3 and the bolts 27 effectively adjusts the impact absorber in place on the steering member 1. This structure prevents displacement of the corrugations 15e,15f,15g from the steering member even if the imposed impact has any offset from the direction toward the steering member. This ensures effective absorption by the impact absorber.

As the adjuster structure further includes the bolts 27 for securing the corrugations 15e,15f,15g with the steering member 1, displacement of the corrugations 15e,15f,15g is further effectively prevented.

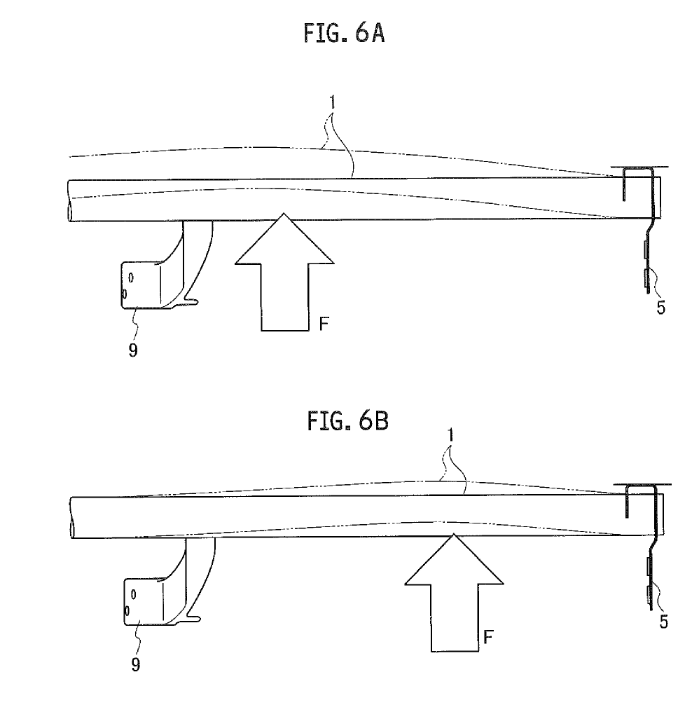

In the meantime, while the steering member 1 first receives the impact transmitted through the box cover 15, the brackets 5, the post-bracket 7 and the installer stays 9 next receive the imposed impact. Referring now to FIGS. 6A and 6B, when the steering member 1 is forced to warp, the end of the steering member 1 supported by the bracket 5 and nearer to the passenger side functions as a fulcrum of warping. Thus the part nearer to this end becomes more rigid.

When the impact load F acts on a part far from the end supported by the bracket 5, deformation of the steering member 1 becomes greater as shown in FIG. 6A, as compared with the case where the same impact load F acts on a part closer to this end as shown in FIG. 6B.

To address the aforementioned issue of unevenness, the corrugation 15g at the laterally outer side may be formed to be lower in strength and/or stiffness than the corrugation 15e at the laterally inner side. To reduce the strength, the corrugation 15g may be formed to be thinner or formed of a weaker or softer material. Of course any other measure is applicable.

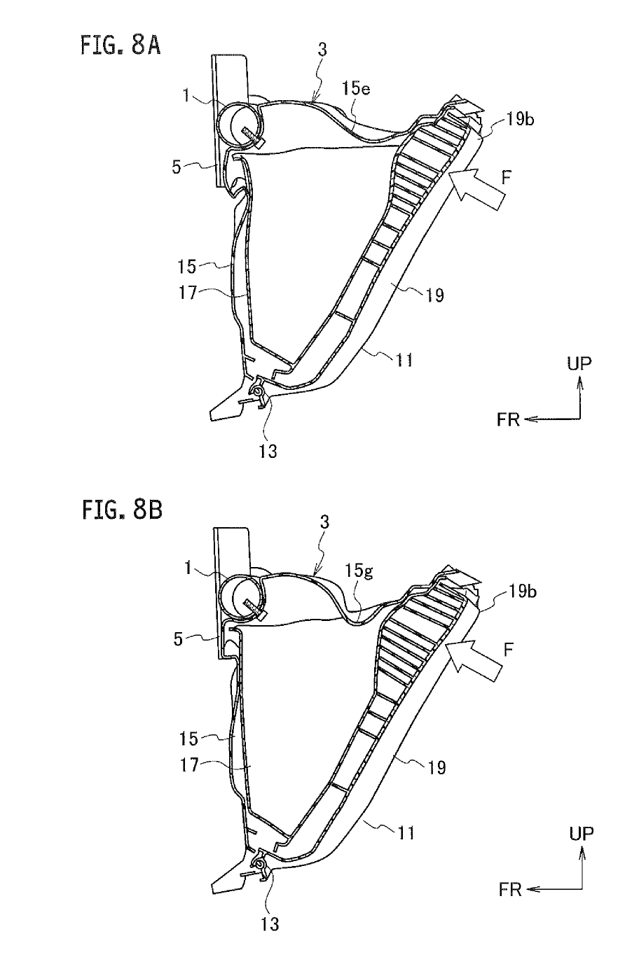

By this measure, deformation at the laterally inner side tends to be smaller as shown in FIG. 8A and deformation at the laterally outer side tends to be greater as shown in FIG. 8B. In sum, deformations at both sides are evened.

When the occupant 29 bumps his/her legs 29a against the glove box 3, this measure evens reactive forces acting on the right and left legs 29a. The occupant 29 is therefore prevented from being thrusted aside or twisted and can keep his/her posture. When an air bag comes into action, the inflated air bag safely supports the occupant 29.

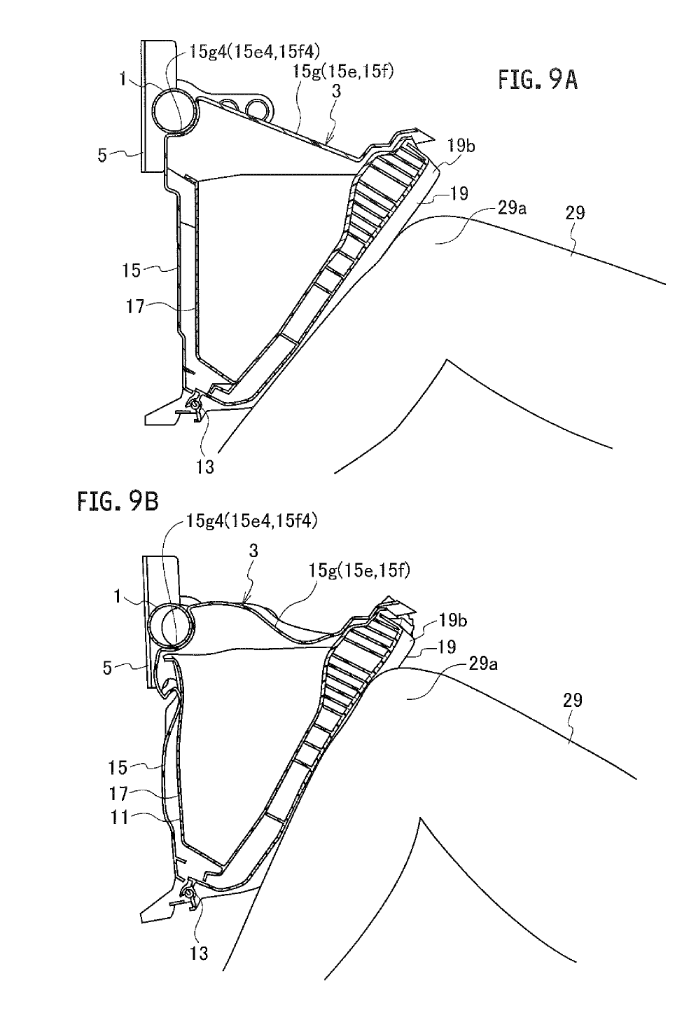

The adjuster structure may have another structure instead of, or in addition to, the bolts 27. Each front face 15e4,15f4,15g4 of the corrugation 15e,15f,15g has a concavity, which is, as shown in FIGS. 9A and 9B, formed to be complementary to the outer periphery of the steering member 1. Each concavity may be a half arc to fit on the steering member 1. More specifically, the concavities are so curved as to fit on the steering member 1.

Even when the corrugations 15e,15f,15g are deformed by the imposed impact as shown in FIG. 9B, the concavities keep catching the steering member 1. Such an adjuster structure also effectively adjusts the impact absorber in place on the steering member 1 and prevents displacement thereof. This structure does not require the bolts 27 and a process of tightening the bolts 27 therein. This effectively reduces the production cost.

Further, the corrugations 15e,15f,15g may be substituted for plate-like ribs projecting upward from the upper wall 15c and interposed between the steering member 1 and the lid 19. In any case, the number of the corrugations or the ribs may not be limited to three, but may be two, four or any arbitrary number.

Although certain embodiments have been described above, modifications and variations of the embodiments described above will occur to those skilled in the art, in light of the above teachings.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed is:

1. An occupant protector comprising:
a steering member elongated in a lateral direction of a vehicle;
a glove box disposed rearward relative to the steering member, the glove box comprising a lid openable to a compartment of the vehicle; and
an impact absorber interposed between the steering member and the lid that is operable to be deformed by and to absorb an impact on the lid.

2. The occupant protector of claim 1,
wherein the glove box comprises:
a box body that is unitary with the lid, and
a support body that supports the box body, and
wherein the impact absorber is formed in a unitary body with an upper side of the support body.

3. The occupant protector of claim 2, wherein the impact absorber comprises one or more corrugations projecting upward from the upper side of the support body.

4. The occupant protector of claim 1, wherein the impact absorber comprises an adjuster structure complementary to the steering member, that adjusts the impact absorber in place on the steering member.

5. The occupant protector of claim 4, wherein the adjuster structure comprises a fastener that fastens the impact absorber to the steering member.

6. The occupant protector of claim 4, wherein the adjuster structure comprises a concavity curved so as to fit on the steering member.

7. The occupant protector of claim 1, wherein the impact absorber comprises a laterally inner side and a laterally outer side lower in strength than the inner side.
